(19) United States
(12) Patent Application Publication
(10) Pub. No.: US 2010/0095266 A1
(43) Pub. Date: Apr. 15, 2010

(54) SYSTEM AND METHOD FOR A POLICY-BASED MANAGEMENT OF A SOFTWARE SERVICE COMPONENT

(75) Inventor: Miroslav Novak, Lipnicka (CZ)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY L.P., Fort Collins, CO (US)

(21) Appl. No.: 12/249,423

(22) Filed: Oct. 10, 2008

(51) Int. Cl. G06F 9/44

(52) U.S. Cl. 717/101

(57) ABSTRACT

A method and appertaining system for implementing the method are provided for managing a software service component in a service oriented architecture (SOA) model, in which aspects maintained by an SOA repository for the service component or software system using the component are made openly available. A series of lifecycle stages for a service component are defined, as are the criteria for promoting the service components to a more advanced life cycle stage. A user/developer/enterprise architect provides a service component at an earlier lifecycle stage and then submits a promotion request for the service component to approver, who assess compliance with the requirement. If the service component complies with the requirement, it is promoted to the next life cycle stage.

### BACKGROUND

Software development paradigms have evolved over the years to accommodate advancements in the software development field. One of the relatively modern developments is the advent of using a service-oriented architecture (SOA) approach. See, e.g., Margolis, Ben, SOA for the Business Developer: Concepts, BPEL, and SCA (Business Developers series) Mc Press (May 15, 2007) ISBN-10: 1583470654; Cerami, Ethan, Web Services Essentials Distributed Applications with XML-RPC, SOAP, UDDI & WSDL (February 2002) ISBN 10: 0-596-00224-6, both herein incorporated by reference.

According to the SOA model, a collection of collaborating services are defined that are integrated into conforming business architectures. Thus the SOA is a component model that interrelates the different functional units of an application, called services, through well-defined interfaces and contracts between these services. The interfaces are defined in a neutral manner that should be independent of hardware platform, operating system, and the programming language in which the service is implemented. This allows services, built on a variety of such systems, to interact with each other in a uniform and universal manner This feature of having a neutral interface definition that is not strongly tied to a particular implementation is known as loose coupling between services. The benefits of a loosely-coupled system are agility and the ability to survive evolutionary changes in the structure and implementation of the internals of each service.

The SOA fundamentally comprises three components: the service provider, the service consumer, and the service registry. The service provider creates a service and in some cases publishes its interface and access information to a service registry. Each provider must decide which services to expose, evaluate trade-offs between security and easy availability, etc. The service registry is responsible for making the service interface and implementation access information available to service consumers. The implementers of a service registry must consider the scope with which the registry will be implemented. For example, there are public service registries available over the Internet to an unrestricted audience, as well as private service registries that are only accessible to users within a company-wide intranet.

Broadly defined, SOA governance is a concept used for activities related to exercising control over services in an SOA. Some key activities that are often mentioned as being part of SOA governance are: 1) managing the portfolio of services: planning development of new services and updating current services; 2) managing the service lifecycle: meant to ensure that updates of services do not disturb current service consumers; 3) using policies to restrict behavior: rules can be created that all services need to apply to, to ensure consistency of services; and 4) monitoring performance of services: because of service composition, the consequences of service downtime or underperformance can be severe. By monitoring service performance and availability, action can be taken instantly when a problem occurs.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an overview of an exemplary basic system;

FIG. 2 is a block flow diagram illustrating the various stages and test requirements for the service component;

FIG. 3A is a flowchart illustrating an example of the process to be used;

FIG. 3B is a flow diagram illustrating a stage transition process;

FIG. 4 is a block diagram illustrating a simplified service test management domain model;

FIG. 5 is a block diagram illustrating an exemplary instance of the lifecycle process; and

FIG. 6 is an exemplary screen shot illustrating an integrated graphical user interface (GUI) that can be used to manage the lifecycle process; and

FIGS. 7A, 7B are exemplary screen shots for the integrated GUI illustrating later details of the relevant stage definitions.

### DETAILED DESCRIPTION OF THE EMBODIMENTS

There will be described a method for managing a service component, comprising: defining a series of lifecycle stages for service components using policy-based artifacts maintained by an SOA repository; defining a requirement in a policy manager by which the service component may be promoted from a first life cycle state to a second life cycle stage; receiving at a SOA repository a promotion request for the service component; assessing compliance of the service component to the requirement in the policy manager in response to the promotion request by referencing data obtained from at least one external source, for instance by accessing web services exposed by other systems; and if the service component meets the requirement, then promoting the service component to the second life cycle stage.

Thus in the present approach, lifecycle constraints and requirements can be expressed as policies, web services enable the integration of different domain models, and policies can validate data provided by web services. The lifecycle process can be implemented as an approval process between multiple lifecycle stages. More specifically, the lifecycle process definition comprises: lifecycle stages that define important points in time when some actions should be undertaken and requirements validated, approvers, who are stakeholders responsible for approval or denial of promotion requests, and conditional transitions that define conditions under which it is legal to proceed to the next lifecycle stage. This is achieved within the concept of a lifecycle framework in which the policies and other requirements can be associated with each stage of the lifecycle of the component.

The approvers invoke a policy management component that checks whether the policy is complied with by reference to data that may be obtained from other sources. These could be, e.g., services (such as REST services) exposed by a service test management (STM) component (described in more detail below).

Lifecycle processes drive users between lifecycle stages. In order to get from an earlier lifecycle stage to the next one, users have to submit a promotion request that will be subject to the approval. If conditions associated with the transition are satisfied and approvers agreed on promotion, the request will be approved and the next lifecycle stage is reached. Accordingly, policy validation is triggered by promotion requests and validation results condition the transition.

Policies enable checking whether input data (e.g., documents) satisfy certain conditions or not. They can check not only artifacts in the SOA repository but also resources exposed by different software components via their web services, such as representational state transfer (REST) services, the REST protocol being used to expose resources. REST services adhere to a set of constraints and architectural principles that include the following: they are stateless, meaning each request from a client to a server must contain all the information necessary to understand the request, and cannot take advantage of any stored context on the server. They have a uniform interface, which is usually taken to mean that the only allowed operations are the HTTP operations: GET, POST, PUT, and DELETE. They are built from resources (pieces of information) that are uniquely identified by Uniform Resource Identifiers (URIs). For example, in a RESTful purchasing system, each purchase order has a unique URI. And, REST components manipulate resources by exchanging representations of the resources. For example, a purchase order resource can be represented by an XML document. Within a RESTful purchasing system, a purchase order might be updated by posting an XML document containing the changed purchase order to its URI.

The use of REST services to obtain the proper representation of a resource and validate it may be achieved by, for example, in the case of a policy that verifies quality aspects of a service, the policy loading a list of defects associated with a service from a URI and checking whether the list contains critical defects.

In addition to the actual requirements that must be fulfilled before the service component advances to the next lifecycle stage, the federated lifecycle process takes advantage of the following: 1) test requirements are specified in early stages of development; 2) quality assurance engineers are notified about lifecycle transitions; 3) services will not be promoted to the next lifecycle status without a quality assurance manager's approval; 4) test suites are developed while services are being implemented; 5) during the testing stage, all tests are executed and they cover all testing requirements; and 6) all major defects must be resolved before deployment to production. With this design, the above may be achieved using appropriately configured policies and an STM system which implements a service (preferably a REST service) that exposes test requirements, tests and defects associated with services.

The federated lifecycle process helps to improve quality of delivered services because users interact with an STM at the right times and can consider service quality information through the whole service lifecycle. Moreover, the same pattern can be applied to other systems, such as those that track service architecture and design, and monitor service performance

Thus, advantageously, with the proposed system and method, it is possible to define federated lifecycle processes covering all important aspects of SOA artifacts maintained by disparate software systems.

The lifecycle stages may include any number of stages, for example, an initial stage, a design stage, a development stage, a testing stage, a production stage, and/or a retirement stage. The requirement for the development stage may comprise that test requirements are specified in the design stage; the requirement for the testing stage may comprise that test suites are defined in the development stage; the requirement for the production stage may comprise that reports are generated in the testing stage; the requirement for the retirement stage may comprise that defects are reported in the production stage; and a further requirement may comprise that tests suites are reused.

Submitting a promotion request may comprise submitting the promotion request by the user to a quality assurance server in order to be handled by the quality assurance personnel. There may actually be a plurality of service components and the requirements can be stored on a plurality of servers.

The requests may be expressed as policies, and the method may comprise checking, by utilizing the policies, whether input data in a form of documents satisfy the requirement, and or whether a satisfaction requirement is met. The method may further comprise checking an artifact located in an SOA artifact repository, and/or checking resources exposed via their web services. These web services may be implemented as representational state transfer (REST) services. The method may further comprise: determining at least one parameter of the services related to service quality; and utilizing the at least one parameter as a criteria for meeting the requirement.

In addition to the method, a system is provided for managing a software service component comprising: a service oriented architecture (SOA) repository comprising policy-based requirements defining criteria for promoting the service component from a first life cycle stage to a second life cycle stage; a promotion request for promoting the service component from the first life cycle stage to the second life cycle stage; an assessment mechanism to determine compliance with the requirement of the service component by referencing data obtained from at least one external source; and a promotion mechanism for enabling promoting the service component from the first life cycle stage to the second life cycle stage.

An “aspect” is a broadly defined term and it can include any metadata associated with a service that is important from a specific perspective. For example, a quality assurance department would likely be most interested in quality assurance attributes of services, such as defects, tests to be run, etc. An operations group would likely be interested in reliability and performance since they have to ensure that service level agreements (SLA) are met—they will be interested in attributes like messages per second, data throughput, availability, etc.

A “domain” or domain model (business model) is defined as the entities/abstractions that a particular organization (e.g., quality assurance) is using—for example, services test management is built on Service, Test Requirements, Tests and Defects.

A “policy”, broadly defined, represents/defines a set of requirements that must be fulfilled. A policy can be validate some resource and thus one determines whether the resources are compliant with the policies or not. The policies may be represented as WS-Policies. Policies comprise assertions—assertions are atomic and simple statements that must be fulfilled; for example, in an XML document, element A must have exactly one sub-element B. It is possible for the system to comprise predefined policies that provide a basic framework for the system, but the system should be flexible so that it can integrate additional policies that are later developed.

Assertions that comprise the policies can be implemented in any language, providing them with great flexibility. For example, assertions may be provided in Java, XQuery and XPath. Java would be suitable for complex logic; XQuery would be suitable when checking the content of XML documents, e.g. a quality assurance policy that a particular service has no critical defects; XPath would be suitable for performing simple checks upon XML documents, e.g., that elements are in a particular namespace

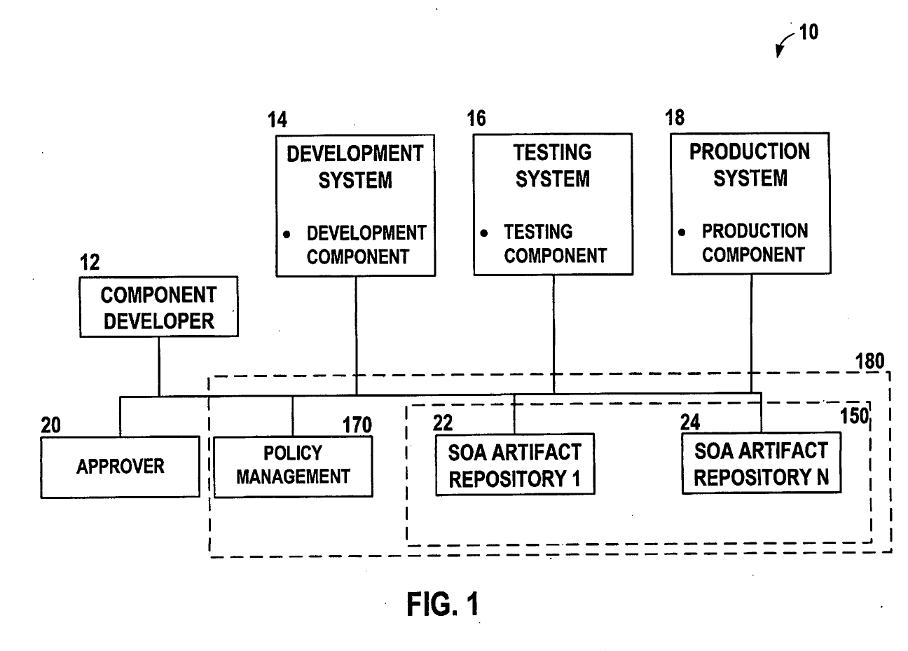

Referring to FIG. 1, there is shown a basic system 10 in which a component developer 12 (or user, depending on the stage) provides a component at a particular lifecycle stage. FIG. 1 shows a development system 14 on which the component undergoes initial design and creation, a testing system 16 that can be used for testing the component against the predefined requirements, and a production system 18 where the properly tested service component that meets the required criteria actually runs. Although FIG. 1 illustrates the systems 14, 16, 18 as separate entities, in theory (although generally not practical), the systems could comprise the same hardware (processors, storage, etc.) and the separation/distinction could be virtual.

Service component(s) descriptions and requirements may be stored in one or more SOA repositories 22, 24. The requirements for advancing the service component to a next stage in the lifecycle are accessed from the repositories 22, 24 by quality assurance personnel 20, who do so in response to a promotion request by the developer/user 12 of the component. These repositories reside within the service catalog 150.

The service catalog 150 provides the foundation of the SOA, providing an enterprise with a single place to organize, understand, and manage information in its SOA. The standards-based architecture of SOA system maximizes interoperability with other SOA products. The service catalog 150 may be used to publish an infrastructure service and then make it available to consumers—it allows governing of services (business services) and other SOA assets. The service catalog 150 would generally be used by, e.g., developers, managers, and system architects, to govern services, to validate policies, to discover services, etc.

A policy manager 170 provides an open and extensible framework that helps development and architecture teams achieve and maintain design consistency. It automates the validation of SOA artifacts and registry content for compliance with corporate guidelines and industry best practice. Policies of the policy manager 170 may be represented as standard WS-Policy documents. The service catalog 150 that includes the artifact repositories 22, 24, and the policy manager 170 can be implemented in an integrated system 180, such as Hewlett Packard's SOA Systinet product.

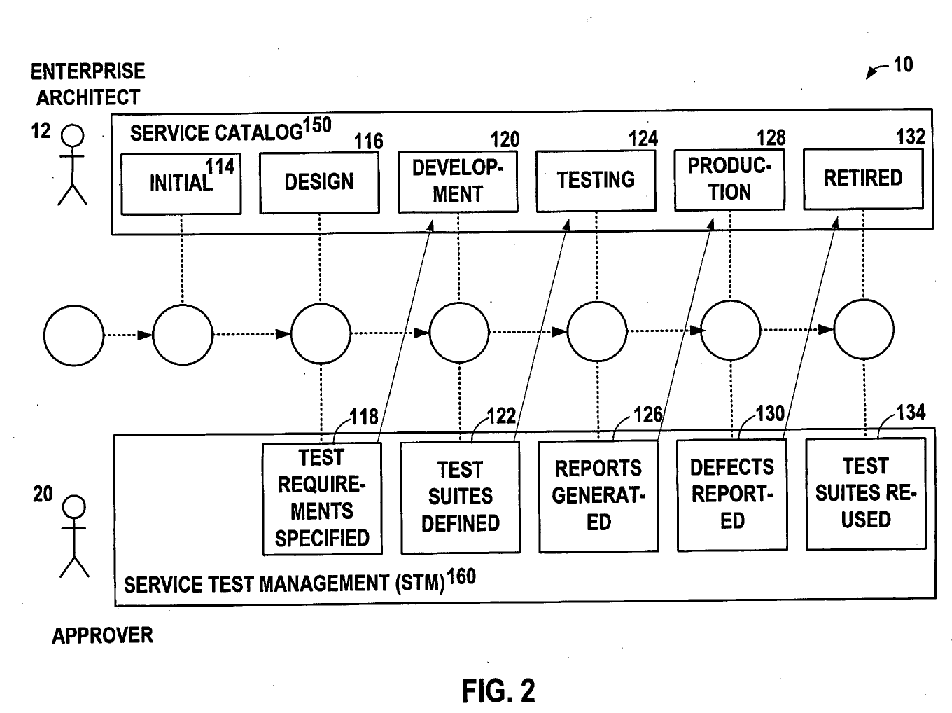

FIG. 2 provides a more detailed illustration of an exemplary system and method 10. The service test management (STM) system 160 is an example of the testing system 16 shown in FIG. 1 and could be provided, e.g., as an add-on to the testing system 16. The STM 160 provides a complete solution for managing the process of testing services and service changes in the SOA systems. The STM 160 integrates with functional testing components to provide a Web-based solution for testing the quality and performance of SOA services throughout the entire application development lifecycle.

The services test management system 160 permits managing of test requirements, tests and defects associated with web services, and permits controlling of which aspects (security, reliability, scalability, etc.) should be and are tested. It can also provide reporting capabilities that help assess quality of services. The services test management system 160 would generally be used by various approvers, such as quality assurance engineers.

The component developer or enterprise architect 12 obtains an initial specification 114 for a service component, and performs an initial design 116 of the service component. Prior to actually developing the component, various test requirements are specified 118. When the enterprise architect 12 wishes to promote the software component from the design stage 116 to the development stage 120 so that component development can begin, they submit a promotion request to the Q/A manager 20 who determines if the test requirements have been specified 118. If not, the service component remains in the design state 116 while the enterprise architect 12 addresses the defects identified by the Q/A manager 20. If the Q/A manager 20 determines that the test requirements have been specified 118, the service component is promoted to the development stage 120, where the development of the service component may begin.

Following through on this example, once the service component has been developed, the enterprise architect 12 submits a promotion request to the Q/A manager 20 to promote the service component to the testing stage 124. The Q/A manager 20 checks the requirement for this stage—here, looking to see if the appropriate test suites have been defined 122. If not, the software component remains at the development stage 120 until the defects are corrected, otherwise, it is promoted to the testing stage 124.

Once the service component has been filly tested, the enterprise architect 12 submits a promotion request to the Q/A manager 20 to promote the service component to the production stage 128. The Q/A manager 20 checks the requirement for this stage—here, looking to see if the appropriate reports have been defined 126. If not, the software component remains at the test stage 124 until the defects are corrected, otherwise, it is promoted to the production stage 128.

Once the service component has served its productive life, the enterprise architect 12 submits a promotion request to the Q/A manager 20 to promote the service component to the retirement stage 132. The Q/A manager 20 checks the requirement for this stage—here, looking to see if the appropriate defects have been reported 130. If so, the service component is promoted to the retirement stage 132. A further requirement may be provided for the provision that the test suites be reused 134. As illustrated in FIG. 2, a service catalog 150 is provided to define the lifecycle stages, and similarly STM 160 is provided to define the various requirements needed at each of the life cycle stages.

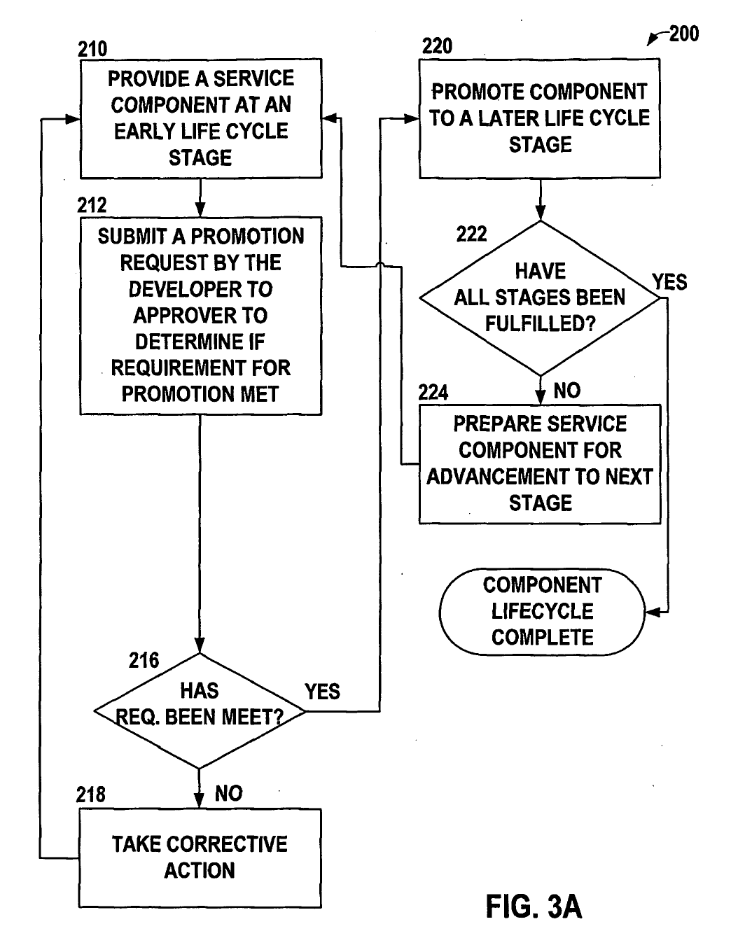

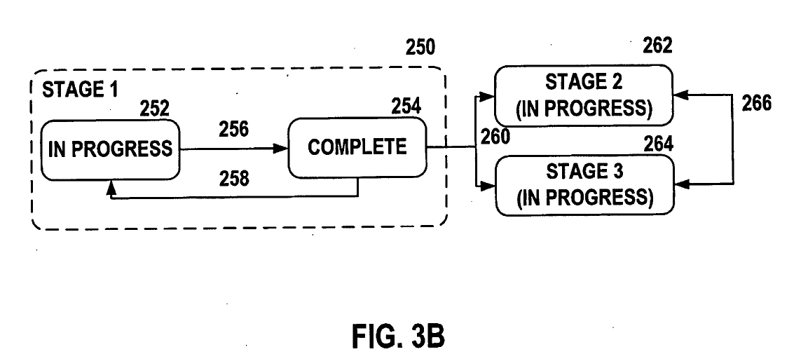

FIG. 3A provides a basic flowchart for a method 200 according to an embodiment of the invention. As noted above, a service component user/developer/enterprise architect 12 provides a service component at some early life cycle stage 210 along with a promotion request to Q/A personnel to promote the service component to the next stage 212. The Q/A personnel determines if the requirement has been met 216, and if not, the user 12 must take corrective action 218 and resubmit the promotion request. If the requirement has been met, then the component is promoted to a later life cycle stage 220.

This process is repeated until all stages in the service component have been filfilled 222—the service component is prepared for advancement to the next stage 224 until the component is ultimately retired and the component lifecycle is completed.

Generally, the lifecycle process definition comprises the stage definitions plus the legal transitions between them, where the stage definition relates to a lifecycle stage and an artifact type. For each stage definition, the following can be defined: policies (validation results considered during approval); tasks (essentially a to-do list of items that users should perform); and approvers (which is a list of any users who will be responsible for an approver; these could include QA engineers, managers, business analysts, enterprise architects, project managers, and others).

FIG. 3B illustrates the stage transition process. Stage 1 250 is “in progress” 252. Here the provisioners complete one or more artifacts, that may include an evaluation of any applicable tasks (manual tasks, policies). A completion approval 256 can be requested by anyone with the proper authority to do so. If the completion approval 256 is given, the stage is deemed complete 254. When the artifact is changed after the stage has been completed, the new revision is automatically set as in progress, with the approval being designated as failed 258. When the stage is complete 254, the approved artifact data (e.g., test results) becomes visible to normal users according to the system requirements. The next stage selection 260 is performed by an owner or other person that has the proper permission. Different stages (stage 2, 262, or stage 3 264) can be selected 266 if there is more than one destination stage.

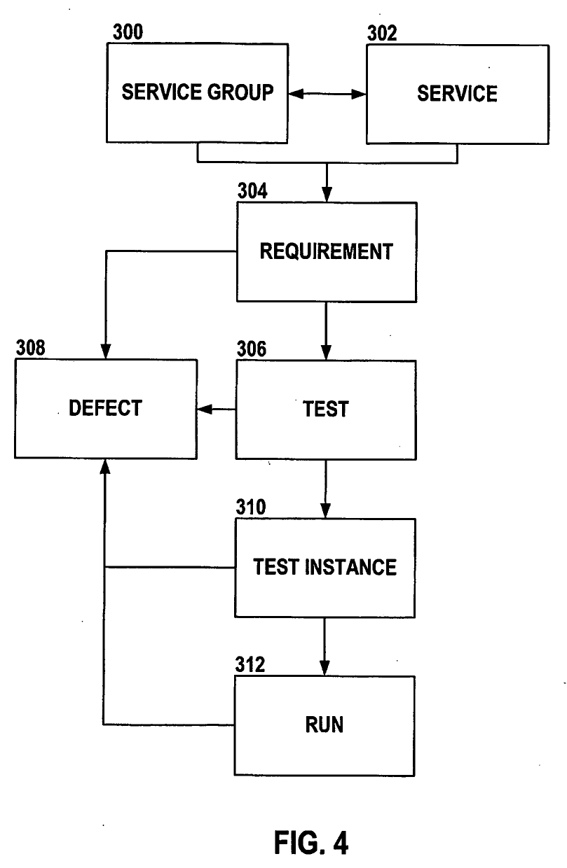

FIG. 4 illustrates a simplified STM domain model depicting that the STM 160 maintains services 302 that can be organized in service groups 300. In the model, requirements (in this example, test requirements 304), tests 306 and defects 308 (via the requirements 304) can be associated with the services 302. The tests 306, when scheduled, are instantiated as test instances 310, where the execution of the test is represented as a run 312. This figure simply provides an example of a particular domain.

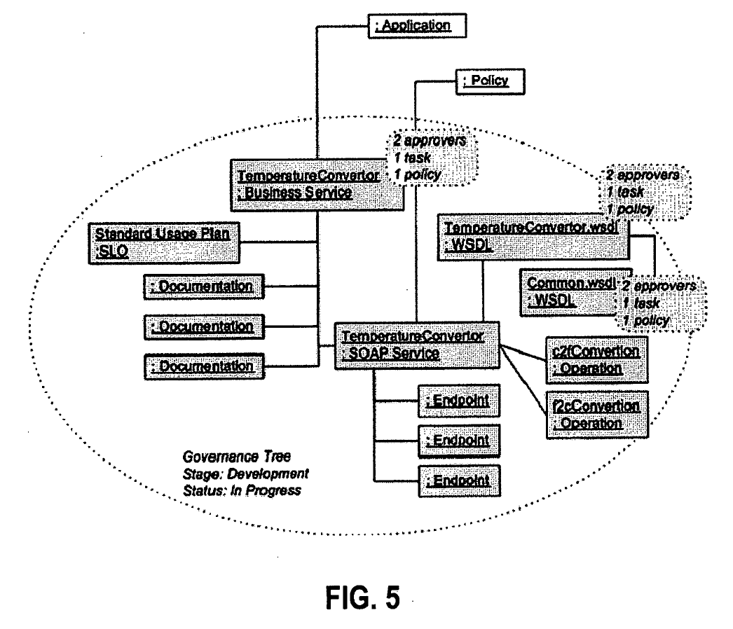

FIG. 5 illustrates a governance tree for an exemplary development stage that is “in progress” for a temperature converter business service. A standard usage plan for the service may include documentation and service level objectives, defined in more detail below—these are two different artefact types that may be utilized. The Documentation rectangles depict some instances of a documentation artefact, and could be in any form, such as a Microsoft Word document. They document the business service, and can be optionally classified, ranging from high-level business requirements to architecture diagrams to low-level technical designs.

Separate from the Documentation, service level objectives (SLO) can be attached to services. FIG. 5 illustrates an example of a simple SLO, which could be, e.g., standard usage conditions for regular consumers. The Documentation and SLOs and other documents are just part of the service definition that contain more information about the service

A WSDL document in XML format provides a description of the network service as a set of endpoints operating on messages containing either document-oriented or procedure-oriented information. The operations and messages are described abstractly, and then bound to a concrete network protocol and message format to define an endpoint. Related concrete endpoints are combined into abstract endpoints (services). Since WSDL is extensible, it allows a description of endpoints and their messages regardless of what message formats or network protocols are used to communicate, and the WSDL document is used in conjunction with SOAP, HTTP GET/POST, and MIME.

Preferably, before promotion, tasks must be complete. In the illustrated example, three tasks must be complete. In general, this number would be, for all artifact types, the sum of the tasks defined for a type multiplied by the number of artifacts of the type.

Promotion requests are sent to approvers as defined in the lifecycle process definition. The requests are sent for an artifact whose type matches the type of the state definition within the lifecycle process. By way of example, if there is a stage definition of Development for the Business Service, then for all Business Services within the Governance Tree, requests are sent, although it is also possible to group such requests so that each approver will receive preferably one, or at least a minimum, of e-mails notifying him about all of the artifacts that he should approve, i.e., if there are five Business Services in a Governance Tree, then an approver could receive only a single e-mail referring to the five Business Services.

Advantageously, in this embodiment, the policy validation is started, approvers are notified, and the approver can approve or reject promotion requests. Based on the process definition, validation results, and approver votes, the promotion succeeds or fails.

The promotion can be started after the tasks (business service, implementation) are complete. If a required policy validation fails before the approvers vote, the promotion fails, the promotion requests are automatically rejected. If a required policy validation fails after all promotion requests have been approved, the promotion fails because the policy is required, and requests are rejected. If the policy is not applicable to the artifact type (business service, implementation), the promotion succeeds because, if the policy is not applicable, the validation finishes immediately without any errors.

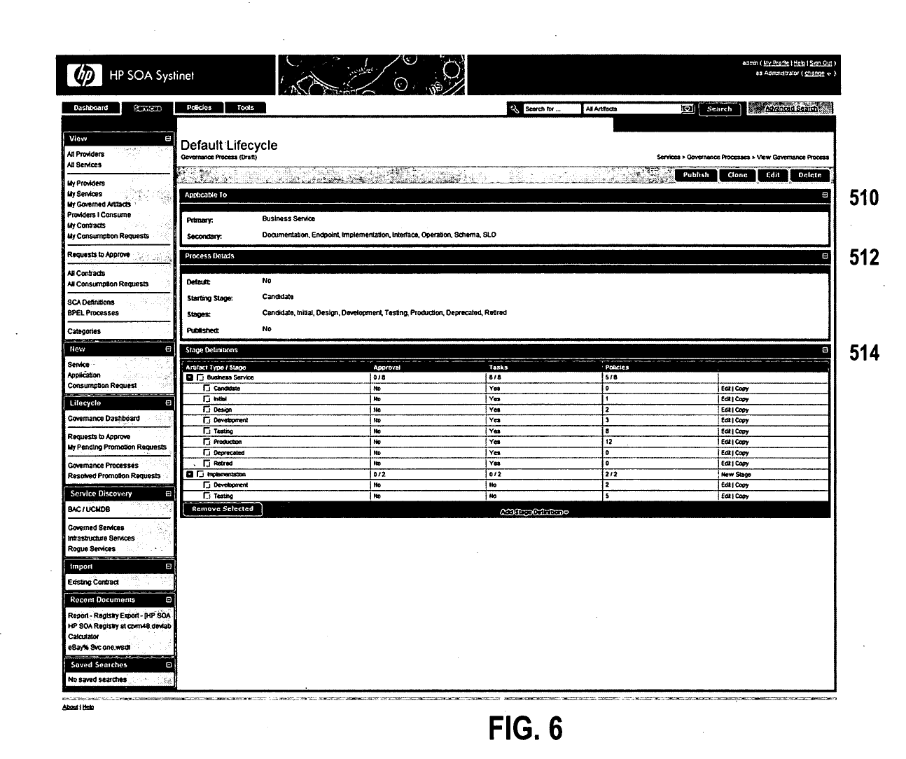

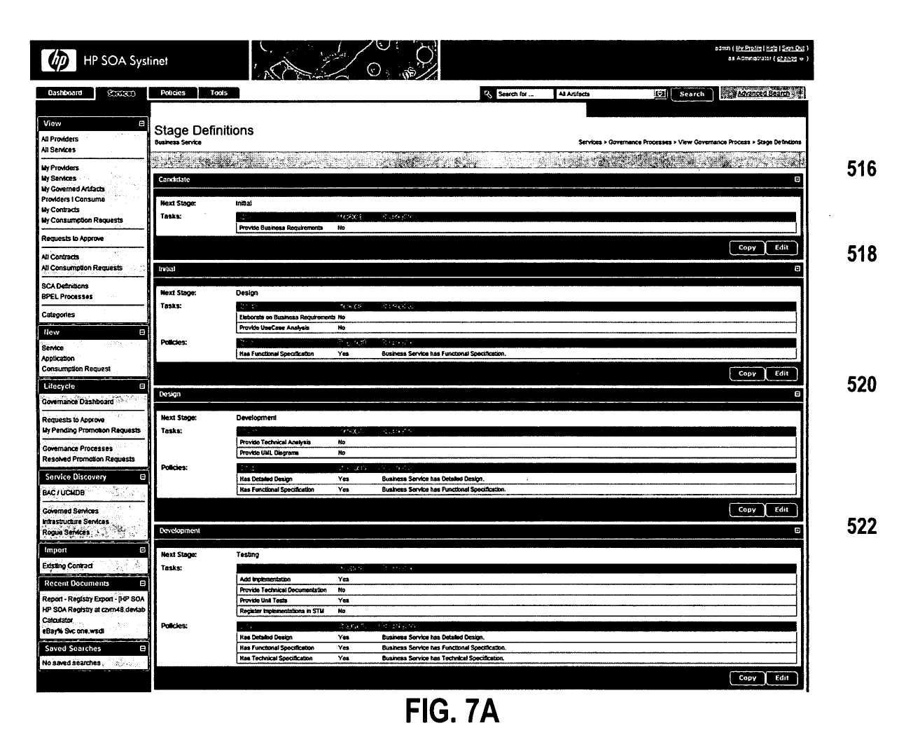

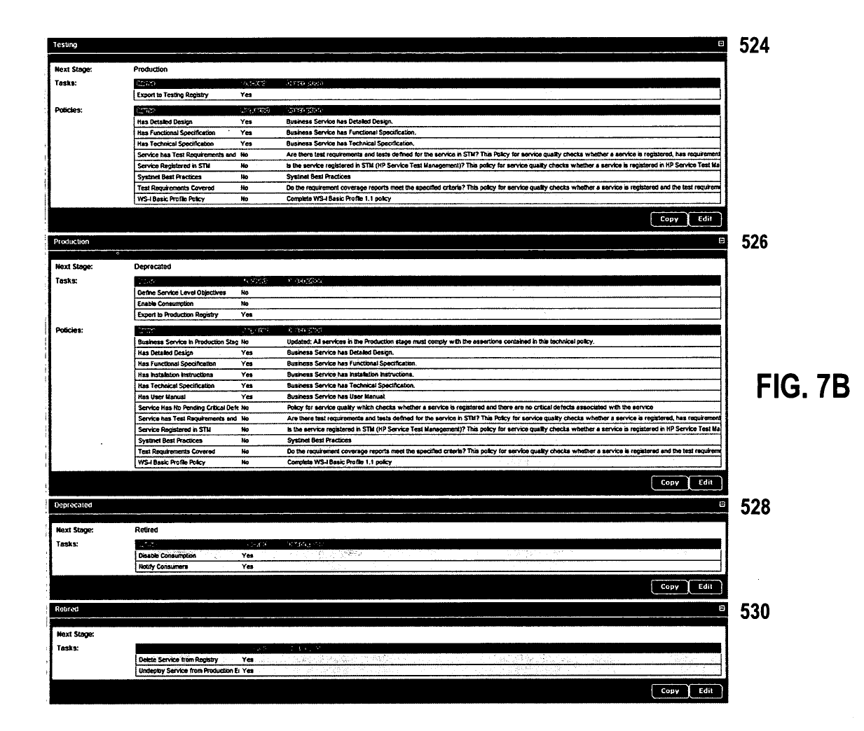

FIG. 6 provides an exemplary screen shot illustrating an integrated graphical user interface (GUI) that can be used to manage the lifecycle process, showing which lifecycle stages for which artifact types are defined, and FIGS. 7A, 7B provide exemplary screen shots for the integrated GUI illustrating later details of the relevant stage definitions, i.e., what the tasks and policies are for each of the lifecycle stages. Collectively, these screens illustrate an integrated tool via which a user can view, track, and update lifecycle stage information.

FIG. 6 illustrates a screen showing how a user might access, via the GUI, the default lifecycle governance process and view the artifact types that are defined for the lifecycle stages. A first area 510 defines what the lifecycle is applicable to. A second area 512 indicates process details, such as the starting stage, all of the stages defined for the service, and whether the service is published. It also provides a third area 514 that defines the stage definitions and gives an overview as to whether a particular stage has been approved, and the number of associated tasks and policies associated with each stage.

FIGS. 7A and 7B illustrate a screen showing how a user might access, via the GUI, the tasks and policies for the various stage definitions. In this example, the stages and respective areas shown on the screen are: candidate 516, initial 518, design 520, development 522, testing 524, production 526, deprecated 528, and retired 530. For each of these, the required tasks and policies are expressly called out. For the tasks, an indication is provided as to whether the requirements are tracked, and for the policies, an indication is provided as to whether these are required. For each, a description may be provided. The screen also permits a person with the proper authority to edit the information associated with each of the stages.

By way of an illustrative concrete example, in order to promote a newly defined service from an initial stage to a design stage, a policy might be defined that in order to promote the service to the next stage, a business requirements document that meets acceptable criteria must be produced. The policy could define criteria, such as the document must be a Microsoft Word document comprising at least twenty pages and comprising three predefined sections. It might also specify a naming convention for the document, and a location at which the document must be stored. The system administrator creates such a document and stores in the defined location. The system administrator then submits a promotion request to an approver.

In the event that the policy can be checked fully automatically (such as if the policy only required the mere presence of the document in Microsoft Word format, and that it be of a certain length), then the promotion can occur automatically. However, certain policies may not lend themselves to such automatic verification—this would be the case if the business requirements document was to be checked for substantive content. In this case the policy would require, at this stage, for an approver to manually review the document and approve its promotion to the next stage.

Advantageously, the manual effort can be minimized in that the approver is not contacted for this manual step unless all of the criteria that can be performed automatically have been determined. Once the automated elements of the policy have been validated, only then is the approver notified that a manual operation is pending for the approval. The promotion is then implemented by, e.g., the approver, having the proper authority, setting a flag in the database.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, JavaScript, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for managing a service component, comprising:
defining a series of lifecycle stages, comprising at least first and second life cycle stages, for service components using artifacts maintained in Service Oriented Architecture (SOA) service catalog;
defining a set of requirements expressed as policies that are related to a stage definition and that are accessible by a policy manager by which the service component may be promoted from the first life cycle stage to the second life cycle stage;
initiating a promotion request from the first life cycle stage to the second life cycle stage;
receiving by the policy manager the promotion request for the service component;
assessing by the policy manager compliance of the service component to the set of requirements associated with the stage definition in response to the promotion request by the policy manager referencing data obtained from at least one external source; and
if the service component is validated by meeting the set of requirements, then promoting within the SOA service catalog, the service component from the first lifecycle stage to the second life cycle stage, and otherwise, not promoting the service component from the first lifecycle.

2. The method according to claim 1, wherein the requirements comprise both at least one automatically verifiable element and at least one manually verifiable element.

3. The method according to claim 2, further comprising:
first assessing, automatically, all automatically verifiable elements for compliance; and
only providing to an assessor the promotion request after all automated elements of the requirements have been validated.

4. The method according to claim 1, wherein the data obtained from the external source is provided by services exposed from other sources.

5. The method according to claim 4, wherein the services are web services exposed by a service test management component.

6. The method according to claim 1, wherein submitting a promotion request comprises submitting the promotion request by the user to a quality assurance server in order to be handled by the approver.

7. The method according to claim 1, wherein the service component comprises a plurality of service components and the requirements are stored on a plurality of servers.

8. The method according to claim 1, wherein the requirements are expressed as WS Policies.

9. The method according to claim 8, further comprising checking, by utilizing the WS Policies, whether input data in a form of documents satisfy the requirement.

10. The method according to claim 8, further comprising checking, by utilizing the WS Policies, a satisfaction requirement.

11. The method according to claim 8, further comprising checking an artifact in an SOA artifact repository.

12. The method according to claim 8, further comprising checking resources exposed via their web services.

13. The method according to claim 12, wherein the web services are representational state transfer (REST) services.

14. The method according to claim 1, further comprising:
determining at least one parameter of the services related to service quality; and
utilizing the at least one parameter as a criteria for meeting the requirement.

15. The method according to claim 1, wherein the requirement is a policy comprising assertions that are implemented in a programming language.

16. The method according to claim 15, wherein the programming language is selected from the group consisting of Java, XQuery, and XPath.

17. The method according to claim 1, wherein promoting the service component further requires votes of one or more approvers in order to promote the service component.

18. A system for managing a software service component, comprising:
a service oriented architecture (SOA) repository comprising policy-based requirements defined as policies that are related to a stage definition and that are accessible by a policy manager defining criteria for promoting the service component from a first life cycle stage to a second life cycle stage;
a promotion request for promoting the service component from the first life cycle stage to the second life cycle stage;
an assessment mechanism to determine compliance with one or more requirements associated with the first life cycle stage of the service component by referencing data obtained from at least one external source; and
a promotion mechanism for enabling promoting the service component from the first life cycle stage to the second life cycle stage if the one or more requirements are met.
